(19) United States
(12) Patent Application Publication
(10) Pub. No.: US 2023/0289695 A1
(43) Pub. Date: Sep. 14, 2023

(54) DATA-DRIVEN PRESCRIPTIVE RECOMMENDATIONS

(71) Applicant: NCR Corporation, Atlanta, GA (US)

(72) Inventors: Shiran Abadi, Tel-Avin (IL); Itamar David Laserson, Givat Shmuel (IL)

(21) Appl. No.: 17/690,185

(22) Filed: Mar. 9, 2022

(51) Int. Cl. G06Q 10/06

(52) U.S. Cl. CPC G06Q 10/06393

(57) ABSTRACT

Metrics are captured from a variety of systems associated with stores of a retailer. Values for factors or benchmarks are calculated per store from their corresponding metrics. Each of the stores are labeled as successful or unsuccessful. Factors for which high values are correlated with successful stores and low values are correlated with unsuccessful stores are clustered together. Similarly, factors for which low values are correlated with successful stores and high values are correlated with unsuccessful stores are clustered together. A set of clustered factors associated with the success, or the failure of stores are reported to the retailer in a data model that also comprises the various degrees to which the various clusters of the factors relate to or correlate with both the successful stores and the unsuccessful stores. Prescriptive recommendations are derived from the data model to improve metrics associated with successful factors.

### BACKGROUND

A store's success is measured by sales, margins, and labor costs, Every retail chain has successful stores, and ones that are lagging behind in terms of performance metrics. But there are hundreds of factors that influence a stores' success. It is very difficult to isolate “quick wins”—opportunities for significant improvement.

In general, a store's success is measured by three main components—sales, margins, and labor costs. Stores that achieve lower numbers in those metrics are considered unsuccessful. A retail chain could significantly increase its annual revenue by improving its lower performing stores. In many cases, there are quick wins that if only correctly identified would bring back substantial revenue with a small amount of effort.

But there are hundreds if not thousands of of factors that influence any given store's success. Since an intricate set of properties affects a store's revenue, it is hard to isolate factors that lead to one store being more successful than another.

Retailers are not only lacking a good enough tool to measure key metrics, but they also lack benchmarking capabilities to compare their stores versus a normal store in their region, chain, or in general. Moreover, even if the problems are detected, retailers struggle to find prescriptive tools that would recommend what a best course of action is in order to raise their numbers higher as fast as possible and with minimal effort.

Furthermore, these types of problems are not just experienced on a macro level by a chain of stores as they are also problematic for departments within a given store on a micro level. In some cases, a given store's poor performance is caused by only a few departments that are dragging that store's performance down. The department leaders need reliable prescriptive tools to discover and change the performance of their individual departments.

### SUMMARY

In various embodiments, system and a method for data-driven prescriptive recommendations are presented.

According to an aspect, a method for data-driven prescriptive recommendations is presented. Metrics are obtained from stores associated with a retailer and measures are calculated for benchmarks of the retailer from the metrics for each store. A first set of the stores is identified as being successful based on at least one measure and a second set of the stores is identified as being unsuccessful based on the at least one measure. The measures for the benchmarks are clustered to distinguish the first set of stores and the second set of stores creating a prescriptive data model and the prescriptive data model is provided to the retailer.

### BRIEF DESCRIPTION OF THE DRAWINGS

FIG. is a diagram of a system for data-driven prescriptive recommendations, according to an example embodiment.

FIG. 2 is a diagram of a method for data-driven prescriptive recommendations, according to an example embodiment.

FIG. 3 is a diagram of another method for data-driven prescriptive recommendations, according to an example embodiment.

### DETAILED DESCRIPTION

FIG. 1 is a diagram of a system 100 for data-driven prescriptive recommendations, according to an example embodiment. It is to be noted that the components are shown schematically in greatly simplified form, with only those components relevant to understanding of the embodiments being illustrated.

Furthermore, the various components (that are identified in FIG. 1) are illustrated and the arrangement of the components is presented for purposes of illustration only. It is to be noted that other arrangements with more or less components are possible without departing from the teachings of data-driven prescriptive recommendations presented herein and below.

Existing retail solutions focus on measuring metrics. The solutions are mostly a descriptive analytics solution focusing on store operations and analytics that measure Key Performance indicators (KPIs) such as revenue, profit margin, labor costs, shrink (loss), etc. The solutions rarely provide benchmarking that identify the cause at low performing metrics and even if they do, they do not isolate the problems that have the most impact nor do they propose any prescriptive recommendations. By and large, retailers rely on talented and clairvoyant store managers and department leaders to use their intuition for purposes of identifying problems and solving the problems. But talented store managers are not easy to find, and their analysis and intuition cannot compete with data-driven models provided herein and below. Moreover, a manager may be able to identify one factor that affects the store's success but it is not always possible to identify multiple factors with codependent effect.

System 100 deploys a variety of mathematical techniques and/or machine learning for developing an evolving model for successful stores and unsuccessful stores and identifying key differences between those that are successful and those that are unsuccessful. Store metrics are gathered, and measures calculated from the metrics are benchmarked. Each different type of benchmark is associated with a unique factor.

The benchmarked and calculated measures are arranged in a table data structure, such that each row represents a given factor (a given measure/benchmark), each column represents a given store, and each cell comprises that store's recorded value for the given factor. The columns are sorted such that “successful stores” (those that exceed a threshold for predefined measures) are aggregated to the left in the table and such that “unsuccessful stores”) (those that fall below the threshold for predefined measures) are aggregated to the right in the table. An order of the rows is then optimized using a clustering algorithm that aggregates factors for which the values increase together in one group of stores and in contrast decrease together in the other group of stores. The clustered groups can be color coded such that low-level factors in a given store are green and high-level factors are red with varying shades of green to red depicted in the table for the clustered groups. The clusters of interest are those factors that are red in all the successful stores and green in the others and vice-versa. This permits identification of factors as the ones that make the difference between successful and unsuccessful stores. These key factors are investigated in order to change unsuccessful stores into successful stores by improving the unsuccessful stores values in the corresponding metrics associated with the key factors.

The factors, by way of example only, comprise cashier proficiency levels for a given store based on transaction throughput calculations from transaction data, the number of voided items per cashier, a total number of transactions per a given time frame; planogram compliance levels for a given store based on video analytics of the items in the store compared to a planogram for the items of the store; total number of out-of-stock items for the given store based on item inventory reports; number of price overrides by cashiers of the given store (indicator of wrong pricing at the given store); average idle times for employees of the given store; Self-Service Terminal (SST) or Self-Checkout (SCO) occupancy levels based on a transaction volume at the SSTs versus overall transaction volume of the given store; promotion compliance levels based on the increase in sales for a given campaign versus sales without the campaign; average response time to counter nearby competitor offers; total value of fraud and theft within a given period of time; replenishment of items on the shelves based on expired items being removed from the shelves (spoilage rate); KPIs by departments; inefficient online transaction fulfillment based on an average fulfillment time for online orders; average checkout wait times (checkout queues) that impact shopper experience (based on visual analytics from video that measures customers wait times in checkout lanes for checkouts); inefficient labor scheduling based on scheduling data that schedules workers for less than optimal shifts determined by threshold shifts; suboptimal store assortment of products based on the item/product catalogue versus a threshold of different products; poor shelf or product labeling based on price lookups at checkout; etc.

System 100 obtains metrics in real time from a variety of store data sources, such as an inventory system, a transaction system, a loyalty system, promotion system, scheduling system, reporting system, security system, and video analytics system. The real time data is periodically processed for each of the factors to calculate values for a given store during a reporting period. The values for each factor may be further compared against predefined thresholds and mapped to a scale associated with benchmarks (for example, high, medium, low, etc.). Each factor is populated to a table data structure, each unique store assigned a column in the table data structure, and each cell of the table represents a given store and a unique factor value. The values for each factor are colored with different shades between red (indicating a high value) and green (indicating a low value). Each store uniquely identified in the table is also labeled as being successful or unsuccessful based on its revenue and/or profit margin (or other KPIs). The columns of the table are then sorted, such that the successful stores appear as columns to the left in the table and unsuccessful stores appear as columns to the right in the table.

Next, a clustering algorithm is processed similar to what is used with gene expression analysis for purposes of clustering the factors (rows within the table) that best distinguish between successful and unsuccessful stores. Eventually, the rows are ordered such that factors that hold high value for a group of stores (e.g., the successful ones) and low values for the other stores (e.g., the unsuccessful ones) are clustered together. Visually, this forms a heat map within the table with three main groups along the vertical axis: (1) with the factors that are red in all or most of the known successful stores and green in all or most of the unsuccessful stores, indicating conclusively high values for success and low values related to failure; (2) factors that are neither unique green nor red for a specific set of stores, indicating indistinctive effect or success or failure; and (3) factors that are green for the successful stores and red for the unsuccessful ones, indicating conclusively low values related to success and high values related to failure.

It is within this context that system 100 is now discussed.

System 100 comprises a cloud/server 110, retail servers 120, and store servers 130.

Cloud/Server 100 comprises a processor 111 and a non-transitory computer-readable storage medium 112, Medium 112 comprises executable instructions for a metric collector 113, a benchmark manager 114, and a model reporter 115. Processor 111 obtains or is provided the executable instructions from medium 112 causing processor 111 to perform operations discussed herein and below with respect to 113-115.

Each retail server 120 comprises a processor 121 and a non-transitory computer-readable storage medium 122, Medium 112 comprises executable instructions for a store manager 123, a promotion/loyalty system 124, and a reporting system 125. Processor 121 obtains or is provided the executable instructions from medium 122 causing processor 121 to perform operations discussed herein and below with respect to 123-125.

Each store server 130 comprises a processor 131 and a non-transitory computer-readable storage medium 132. Medium 132 comprises executable instructions for a transaction system 133, an inventory system 134, a scheduling system 135, and a security/video analytics system 136.

During operation, metric collector 133 is configured to obtain metrics from a plurality of store servers 130 associated with a given retailer of a given retail server 120. The metrics are obtained from each of the store servers 130 and the corresponding retail server 120 from data produced by transaction system 133, inventory system 134, scheduling system 135, security/video analytics system 136, promotion/loyalty system 124, and reporting system 125.

The metrics comprise a variety of data, by way of example only, such as and by way of example only, transaction identifiers for transactions, terminal type (Point-Of-Sale (POS) terminal, SST), transaction type (self-service, cashier-assisted, refund, purchase), transaction events (price overrides, promotions, voids, refunds, price lookups, transaction start time, transaction end time, etc.), transaction information (item code, item category, item price, item quantity, item weight, etc.), store identifier, terminal identifier, loyalty and promotion information (loyalty account, promotion campaign identifier, promotion redemption, promotion type, etc.), item inventory levels per item per store, planogram of items in each store, scheduling data per employee of a given store, scheduling data per day within a given period of a given store, etc., average wait times per customer per store within a given period, total amount by dollar value of theft or fraud per store within a given period, average online fulfillment times for online orders during a given period, average response time per store to competitor offers/campaigns within a given period, etc.

The metrics are passed to benchmark manager 114 by metric collector 113. Manager 114 calculates measures or values for each factor or benchmark associated with each store of a given retailer for a given retail server 120. For example the metrics associated with a total number of transactions at a given store during the period for the POS terminal type is associated with cashiers performing transaction at that store. An average throughput for the transactions can be calculated as an average total number of items for the transactions over an average transaction time (calculated from the transaction start and end times) for the transactions (avg total number of items/average transaction time). A total number of voids, overrides, and price lookups for the transaction can be obtained. The average throughput combined with the total number of voids, overrides, and price lookups can be mapped to a cashier proficiency for the given store. The SST occupancy benchmark can be calculated from the total number of SST terminal type transactions for the given period divided by the total transactions associated with both the total number of SST terminal type transactions and the total number of POS terminal type transactions. Manager 114 calculates the metrics into values or measures associated with each factor of each store.

Manager 114 populates a table data structure with the factors as rows, the store identifiers for the stores as the columns, and each cell comprising the corresponding measure of value for the corresponding store identifier and factor combination.

Manager 114 indicates through a message to model reporter 115 that a new raw set of factor comparison data for the given retailer is ready for modeling via a link to the table data structure. Reporter 115 uses an Application Programming Interface (API) to request that store manager 123 identify via store identifiers, which stores were deemed successful for the given period and which stores were deemed to by unsuccessful. Alternatively, Reporter 115 may use predefined KPIs, such as revenue and/or profit margin identified by the retailer to automatically identify each store in the table as being successful or unsuccessful for the given period using the KPIs and the measures calculated from the metrics by manager 114, such that no interaction is needed between store manager 123 and reporter 115.

Each of the store identifiers identified as being successful for the given period are sorted to the leftmost columns in the table data structure and each store identified as being unsuccessful for the given period are sorted to the rightmost columns in the table data structure by reporter 115.

Next, the rows or factors of the table are processed by a clustering algorithm such as K-means, Centroid-based, Mean-Shift, etc. The output of the clustering algorithm clusters the factors or rows together in the table data structure that appear related and caustic for the successful stores and unsuccessful stores. The output of the clustering algorithm also clusters the factors or rows together in the table that appear to decrease together or appear unrelated to one another. Essentially, rows/factors are ordered within the table in clusters when theft values/measures in the corresponding cells increase together in a group (successful or unsuccessful stores) or decrease together in the group. Each factor in the table is assigned a color according to a color graduation according to its value, After clustering is processed, all factors that are high for one group but low for the other group will be clustered, and thus a clear distinction between red and green (high and low values) will be clearly visible. The table now comprises a heat map of clustered and ordered factors for the successful stores and the unsuccessful stores. Notably, red and green are not directly related with success or failure of a store, but factors that hold different colors for the two groups have the most distinctive effect on success or failure of a given store.

Report manager 115 then reports the table in a heat map graphical format and/or text-based description to store manager 123 using an API. The text-based description can identify successful store identifiers, factor labels identified as being most caustic or related to their success, and each successful store's measures (values) for each of the factor labels along with identifying unsuccessful store identifiers, factor labels identified as being most caustic or related to their failure, and each unsuccessful store's measures for each of the factor labels.

In an embodiment, each individual store can use model reporter 115 for purposes of optimizing individual departments by identifying factors contributing to successes and failures in a given department of a given store versus the same departments of other stores for the retailer. In this scenario, the columns remain the store identifiers and are labeled as successful or unsuccessful based on KPIs. The measures calculated by benchmark manager 114 are for measures associated with a given department of the retailer.

Thus, different levels of granularity are achievable for a retailer based on a store-to-store comparison or a department within a store to a same department within the other stores comparison.

System 100 continuously changes as success factors change, such that the data model provided via the table is dynamic, learning, and adaptive driven by current success factors of successful stores. System 100 provides a data-driven prescriptive recommendation on success factors that are needed to move an unsuccessful store to a successful store. The correlation between clusters of factors with an identified successful store are automatically identified and provided as an optimal set of factors that correlate to successful stores. Additionally, a set of factors that correlate with unsuccessful stores are identified and provided with the data model such that these factors can be avoided.

In an embodiment, the data associated with the metrics for the stores is housed on cloud/server 110 and accessible directly to metric collector 113.

In an embodiment, the data associated with the metrics for the stores is housed on retail server 120 and obtained through an API by metric collector 113 via store manager 123.

In an embodiment, some of the data associated with the metrics for the stores is housed on cloud/server 110 and other portions of the data associated with the metrics is housed on retail server 120.

In an embodiment, some or all of the benchmarks or measures/values for the factors are maintained by reporting system 125 and obtained via an API by benchmark manager 114 as needed.

In an embodiment, system 100 is provided to a given retailer associated with retail server 120 as a Software-as-a-Service (SaaS).

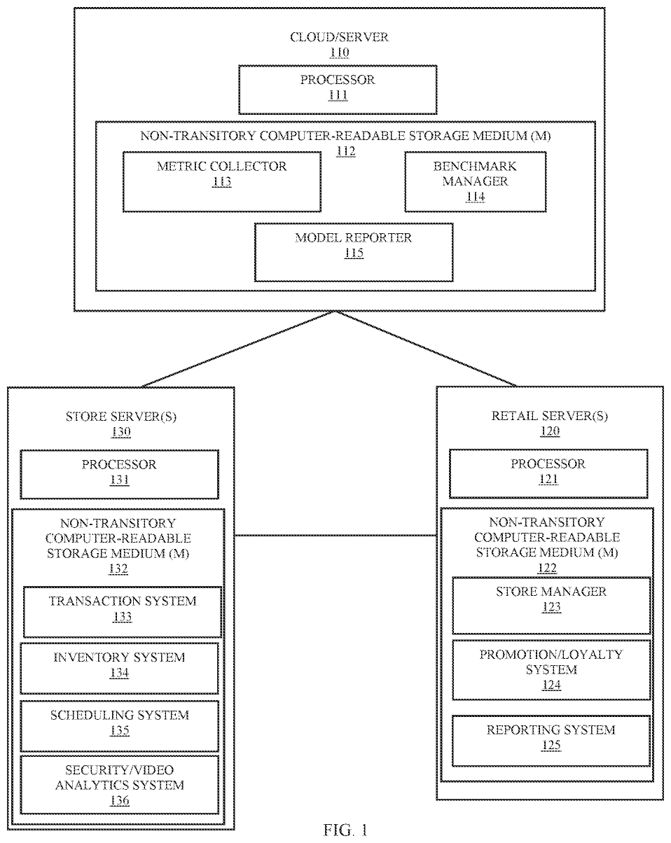

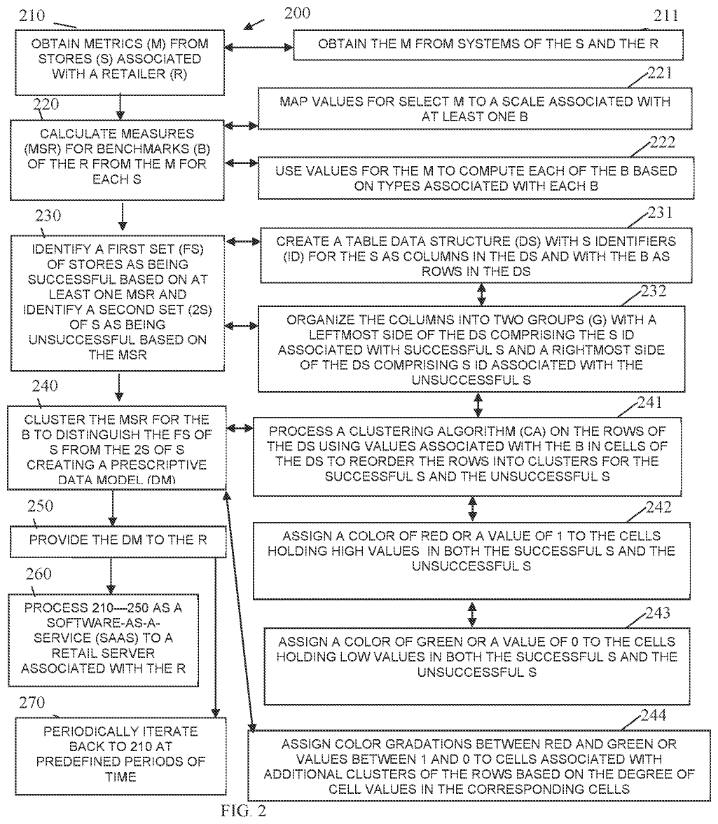

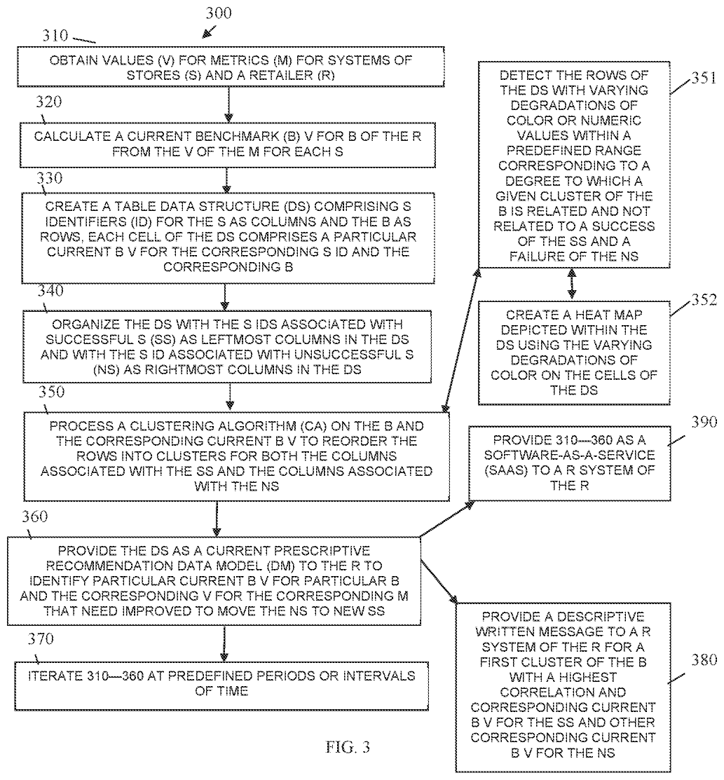

The above-referenced embodiments and other embodiments are now discussed with reference to FIGS. 2-3.

FIG. 2 is a diagram of a method 200 for data-driven prescriptive recommendations, according to an example embodiment. The software module(s) that implements the method 200 is referred to as an “success factor identifier.” The success factor identifier is implemented as executable instructions programmed and residing within memory and/or a non-transitory computer-readable (processor-readable) storage medium and executed by one or more processors of one or more devices. The processor(s) of the device(s) that executes the success factor identifier are specifically configured and programmed to process the success factor identifier. The success factor identifier has access to one or more network connections during its processing. The connections can be wired, wireless, or a combination of wired and wireless.

In an embodiment; the device that executes the success factor identifier is cloud 110. In an embodiment, the device that executes success factor identifier is server 110.

In an embodiment, the success factor identifier is all of, or some combination of metric collector 113, benchmark manager 114, and/or mod& reporter 115.

In an embodiment, the success factor identifier is provided to a retail server 120 and/or a store server 130 as a SaaS.

At 210, success factor identifier obtains metrics from stores associated with a retailer.

In an embodiment, at 211, the success factor identifier obtains the metrics from systems (133-136) of the stores and the retailer (124-125).

At 220, the success factor identifier calculates measures for benchmarks of the retailer from the metrics for each store.

In an embodiment, at 221, the success factor identifier maps values for select metrics to a scale associated with at least one benchmark.

In an embodiment, at 222, the success factor identifier uses values for the metrics to compute each of the benchmarks based on types associated with each benchmark. Each type of benchmark is associated with a formula processed against specific metric values to calculate the corresponding benchmark value (measure).

At 230, the success factor identifier identifies a first set of stores as being successful based on at least one measure and identifies a second set of stores as being unsuccessful based on that measure.

In an embodiment, at 231, the success factor identifier creates a table data structure with store identifiers for the stores as columns in the table data structure and with the benchmarks as rows in the table data structure.

In an embodiment of 231 and at 232, the success factor identifier organizes the columns into two groups with a leftmost side of the table data structure comprising the store identifiers for the successful stores and a rightmost side of the table data structure comprising the store identifiers for the unsuccessful stores.

At 240, the success factor identifier clusters the measures for the benchmarks to distinguish the first set of stores from the second set of stores creating a prescriptive data model.

In an embodiment of 232 and 240, at 241, the success factor identifier processes a clustering algorithm on the rows of the table data structure using values associated with the benchmarks in cells of the table data structure to reorder the rows into clusters for the successful stores and the unsuccessful stores.

In an embodiment of 241 and at 242, the success factor identifier assigns a color of red or a value of 1 to the cells holding high values in both the successful stores and the unsuccessful stores.

In an embodiment of 242 and at 243, the success factor identifier assigns a color of green or a value of 0 to cells low values in both the successful stores and the unsuccessful stores.

In an embodiment of 243 and at 244, the success factor identifier assigns color gradations between red and green or values between 1 and 0 to the cells associated with additional clusters of the rows based on the degree of cell values in the corresponding cells.

At 250, the success factor identifier provides the prescriptive data model to the retailer.

In an embodiment, at 260, the success factor identifier is processed as a SaaS to a retail server associated with the retailer.

In an embodiment, at 270, the success factor identifier (210-250) periodically iterates back to 210 at predefined periods or intervals of time.

FIG. 3 is a diagram of another method 300 for data-driven prescriptive recommendations, according to an example embodiment. The software module(s) that implements the method 300 is referred to as a “data-driven success factor modeler.” The data-driven success factor modeler is implemented as executable instructions programmed and residing within memory and/or a non-transitory computer-readable (processor-readable) storage medium and executed by one or more processors of one or more devices. The processor(s) of the device(s) that executes the data-driven success factor modeler are specifically configured and programmed to process the data-driven success factor modeler. The data-driven success factor modeler has access to one or more network connections during its processing. The network connections can be wired, wireless, or a combination of wired and wireless.

In an embodiment, the device that executes the data-driven success factor modeler is cloud 110. In an embodiment, the device that executes the data-driven success factor modeler is server 110.

In an embodiment, the data-driven success factor modeler is all of, or some combination of metric collector 113, benchmark manager 114, model reporter 115, and/or method 200.

The data-driven success factor modeler presents another and, in some ways, enhanced processing perspective from that which was discussed above with the method 200 of the FIG. 2.

In an embodiment, the data-driven success factor modeler is provided to a retail server 120 and/or a store server 130 as a SaaS

At 310, the data-driven success factor modeler obtains values for metrics for systems (133-136 and 124-125) of stores and a retailer.

At 320, the data-driven success factor modeler calculates a current benchmark value for benchmarks of the retailer from the metric values for each store.

At 330, the data-driven success factor modeler creates a table data structure comprising store identifiers for the stores as columns and the benchmarks as rows, each cell of the table data structure comprises a particular current benchmark value for the corresponding store identifier and the corresponding benchmark.

At 340, the data-driven success factor modeler organizes the table data structure with the store identifiers associated with the successful stores as leftmost columns in the table data structure and with the store identifiers associated within the unsuccessful stores as rightmost columns in the table data structure.

At 350, the data-driven success factor modeler processes a clustering algorithm on the benchmarks and the corresponding current benchmark values to reorder the rows into clusters for both the columns associated with the successful stores and the columns associated with the unsuccessful stores.

In an embodiment, at 351, the data-driven success factor modeler detects the rows (factors—benchmark values) of the table data structure with varying degradations of color or numeric values within a predefined range corresponding to a degree to which a given cluster of the benchmarks is related and is not related to a success of the successful stores and a failure of the unsuccessful stores.

In an embodiment of 351 and at 352, the data-driven success factor modeler creates a heat map depicted within the table data structure using the varying degradations of color on the cells in the table data structure.

At 360, the data-driven success factor modeler provides the table data structure as a current prescriptive recommendation data model to the retailer to identify particular current benchmark values for particular benchmarks and the corresponding values for the corresponding metrics that need improved to move the unsuccessful stores to new successful stores.

In an embodiment, at 370, the data-driven success factor modeler iterates (310-360) at predefined periods or intervals of time.

In an embodiment, at 380, the data-driven success factor modeler provides a descriptive written message to a retailer system of the retailer for a first cluster of the benchmarks with a highest correlation and corresponding current benchmark values for the successful stores and other corresponding current benchmark values for the unsuccessful stores.

In an embodiment, at 390, the data-driven success factor modeler (310-360) is provided as a SaaS to a retail server or a retail system of the retailer.

It should be appreciated that where software is described in a particular form (such as a component or module) this is merely to aid understanding and is not intended to limit how software that implements those functions may be architected or structured. For example, modules are illustrated as separate modules, but may be implemented as homogenous code, as individual components, some, but not all of these modules may be combined, or the functions may be implemented in software structured in any other convenient manner.

Furthermore, although the software modules are illustrated as executing on one piece of hardware, the software may be distributed over multiple processors or in any other convenient manner.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus, the following claims are hereby incorporated into the Description of the Embodiments, with each claim standing on its own as a separate exemplary embodiment.

1. A method, comprising:
obtaining metrics from stores associated with a retailer;
calculating measures for benchmarks of the retailer from the metrics for each store;
identifying a first set of the stores as being successful based on at least one measure and identifying a second set of the stores as being unsuccessful based on the at least one measure;
clustering the measures for the benchmarks to distinguish the first set of stores from the second set of stores creating a prescriptive data model; and
providing the prescriptive data model to the retailer.

2. The method of claim 1 further comprising, processing the method as a Software-as-a-Service to a retail server associated with the retailer.

3. The method of claim 1 further comprising, periodically iterating back to the obtaining at predefined periods of time.

4. The method of claim 1, wherein obtaining further includes obtaining the metrics from systems of the stores and the retailer.

5. The method of claim 1, wherein calculating further includes mapping values for select metrics to a scale associated with at least one benchmark.

6. The method of claim 1, wherein calculating further includes using values for the metrics to compute each of the benchmarks based on types associated with each benchmark.

7. The method of claim 1, wherein identifying further includes creating a table data structure with store identifiers for the stores as columns in the table data structure and with the benchmarks as rows in the table data structure.

8. The method of claim 7, wherein creating further includes organizing the columns into two groups with a leftmost side of the table data structure comprising the store identifiers associated with the successful stores and with a rightmost side of the table data structure comprising the store identifiers associated with the unsuccessful stores.

9. The method of claim 8, wherein clustering further includes processing a clustering algorithm on the rows of the table data structure using values associated with the benchmarks in cells of the table data structure to reorder the rows into dusters for the successful stores and the unsuccessful stores.

10. The method of claim 9, wherein processing further includes assigning a color of red or a value of 1 to the cells holding high values in both the successful stores and the unsuccessful stores.

11. The method of claim 10, wherein assigning further includes assigning a color of green or a value of 0 to the cells holding low values in both the successful stores and the unsuccessful stores.

12. The method of claim 1, wherein assigning further includes assigning color gradations between red and green or values between 1 and 0 to the cells associated with additional dusters of the rows based on cell values held in the corresponding cells.

13. A method, comprising:
obtaining values for metrics from systems of stores and a retailer associated with the stores;
calculating current benchmark values for benchmarks of the retailer from the values of the metrics for each store;
creating a table data structure comprising store identifiers for the stores as columns and the benchmarks as rows, each cell of the table data structure comprises a particular current benchmark value for the corresponding store identifier and the corresponding benchmark;
organizing the table data structure with the store identifiers associated with successful stores as leftmost columns in the table data structure and with the store identifiers associated with unsuccessful stores as rightmost columns in the table data structure;
processing a clustering algorithm on the benchmarks and the corresponding current benchmark values to reorder the rows into clusters for both the columns associated with the successful stores and the columns associated with the unsuccessful stores; and
providing the table data structure as a current prescriptive recommendation data model to the retailer to identify particular current benchmark values for particular benchmarks and the corresponding values for the corresponding metrics that need improved to move the unsuccessful stores to new successful stores.

14. The method of claim 13 further comprising, iterating the method at predefined periods or intervals of time.

15. The method of claim 13 further comprising, providing a descriptive written message to a retailer system of the retailer for a first cluster of the benchmarks with the highest correlation and corresponding current benchmark values for the successful stores and other corresponding current benchmark values for the unsuccessful stores.

16. The method of claim 13, wherein processing further includes detecting the rows of the table data structure with varying degradations of color or numeric values within a predefined range corresponding to a degree to which a given cluster of the benchmarks is related and not related to a success of the successful stores and a failure of the unsuccessful stores.

17. The method of claim 13, wherein labeling further includes creating a heat map depicted within the table data structure using the varying degradations of color on the cells of the table data structure.

18. The method of claim 13 further comprising, processing the method as a Software-as-a-Service (SaaS) to a retailer system of the retailer.

19. A system, comprising:
a cloud server comprising at least one processor and a non-transitory computer-readable storage medium;
the non-transitory computer-readable storage medium comprises executable instructions;
the executable instructions when provided to and executed by the at least one processor from the non-transitory computer-readable storage medium cause the at least one processor to perform operations comprising:
obtaining metrics from systems of stores and a retailer associated with the stores;
identifying successful stores and unsuccessful stores from the stores based on a current benchmark value calculated from select values associated with select metrics;
calculating additional benchmark values for benchmarks associated with the retailer for each store using values associated with the metrics;
creating a table data structure comprising the benchmarks as rows, successful store identifiers for the successful stores as a first set of columns in the table data structure organized to a leftmost side in the table data structure, unsuccessful store identifiers for the unsuccessful stores as a second set of columns in the table data structure organized to a rightmost side in the table data structure, and each cell comprising the corresponding benchmark value for a corresponding pair of a given benchmark and a given store identifier;
processing a clustering algorithm on the table data structure to reorder the rows of the table data structure based on correlations between the corresponding benchmark values in the cells, the successful store identifiers, and the unsuccessful store identifiers and obtaining as output from the clustering algorithm dusters of the benchmarks; and
providing the table data structure with visual attributes or numeric values superimposed on the cells based on the dusters to a retail system of the retailer as a prescriptive recommendation data model for the retailer to identify specific benchmark values for specific benchmarks that need changed in the unsuccessful stores to move the unsuccessful stores to successful stores.

20. The system of claim 19, wherein the executable instructions are accessible as a Software-as-a-Service (SaaS) to one or more of a retail server of the retailer and the retail system of the retailer.
